(19) United States
(12) Patent Application Publication
(10) Pub. No.: US 2007/0290882 A1
(43) Pub. Date: Dec. 20, 2007

(54) Domotic System Provided With Centralized Controlling and Managing Hardware and Software for Remote Management of Domestic Appliances, Apparatuses, Installations, Devices and Machines Existing in a House

(75) Inventors: Giuseppe Consorte, Conversano (IT); Leonardo D'Alessandro, Conversano (IT); Antonio Sacchetti, Conversano (IT)

Correspondence Address: YOUNG & THOMPSON, 745 SOUTH 23RD STREET, 2ND FLOOR, ARLINGTON, VA, 22202, US

(73) Assignee: Matrix S.R.L., Conversano (BA) (IT)

(21) Appl. No.: 11/663,732

(22) PCT Filed: Sep. 29, 2005
(86) PCT No.: PCT/IT05/00562

§ 371 Date: Mar. 26, 2007

(30) Foreign Application Priority Data
Sep. 29, 2004 (IT) BA2004A000042

(51) Int. Cl. G08C 17/02

(52) U.S. Cl. 340/825.72

(57) ABSTRACT

A domotic system (1B) for the centralized drive, control and management of domestic appliances, devices, apparatuses, installations (4.1 . . . 4.n) existing in a dwelling-house, consisting of a logic unit (2) of remote drive, control and management and a plurality of the apparatuses, devices and installations (4.1 . . . 4.n), characterized in that the apparatuses, devices and installations (4.1 . . . 4.n) are provided each with wireless communication elements (20) by which they are remote driven, controlled and managed by the remote logic unit (2) which is also provided with its own central wireless communication elements (23).

The present invention relates to a novel domotic system provided with centralized controlling and managing hardware and software for the remote control of household appliances, apparatuses, installations, devices and machines existing in a dwelling-house.

Presently produced household appliances such as refrigerators, boilers, washing machines, dishwashers, ovens, air-conditioners, etc. are equipped with mechanical and electronic devices provided with a drive and control software which is installed upon manufacturing directly by the constructor inside the appliances so that it can be interfaced with centralized remote control systems.

Domotic systems and agencies have been recently developed with the aim at the remote control of a plurality of domestic appliances, apparatuses, installations, devices and machines existing in a dwelling-house.

A practical example was given by Sun Microsystems in 1999 using the Jini technology which is based upon the Java language and TCP-IP (communication protocols via Internet) and allows objects different from one another such as a washing machine, a printer, a hard disk to be connected by using net protocols over one so-called cooperative net where there is no central service-providing unit but everybody takes part with its own capability in helping everyone is needing service. These services are dynamical both by number and type.

A domotic agency is a recent development of the domotic systems and includes a plurality of such systems allowing all those functions of a dwelling-house where a machine can emulate the man to be managed as well as all home devices to be remote monitored and controlled by typical communication means that are widespread today such as mobile phone, electronic mail (e-mail), and web browser. The emulation takes place by inference providing a sole central supervisor agent. The inferential motor usually consists of a software packet.

Some approaches to the problem of creating a domestic net with remote controlled devices are mentioned in the literature and exist on the market, however, such control keeps a low profile today. High-level control means such as conveyed-wave systems, for example a modulation of the electric current at 50-60 Hz to switch on/off devices from a central system, are known but rarely used nowadays.

Recently, other transmission means (telephone lines, radiofrequency, infrared) and their applications such as domestic net for data transfer, complex control means for single devices, voice control, power consumption control, direct connection to internet.

A the same time “smart” devices have been put on the market consisting of simple devices with newly added functionalities, e.g. an oven connected to internet to download recipes, a refrigerator that sends messages about what is missing, etc.

There are also little integrated systems having only one purpose, for example, the control of the home lights or the home alarm system.

The ways of integrating all systems in only one with the benefits involved have been investigated only for the last years.

However, except for single inventions and ad hoc embodiments there is still no system able to integrate in a flexible, dynamic manner all apparatuses, devices, and subsystems of a dwelling-house today even if Jini technology has recently solved the problem of the connection and communication between a plurality of different devices, thus becoming the standard system for the mutual communication and the starting point for the construction not only of a domotic system but a domotic agency.

One main drawback connected to the present domotic systems is correlated to the early obsolescence of the software installed in particular on the household appliances which often occurs even in the space of a few months. In fact, such software is installed on the single household appliances by the relative companies upon manufacturing, and cannot easily be updated by the same companies to improve next developed functions and programs. It should be noted, for example, that the already purchased washing machines and dishwashers might use new cleansing agents allowing different washing programs to be carried out instead of those programmed with a desirable reduction in the consumption both of cleansing agents and washing water. Therefore, a washing machine of the present domotic systems has the limitation of a software that cannot easily be updated.

A further drawback of the present domotic systems which is certainly not a minor problem with respect to the above-mentioned system mainly depends on that they have an additional considerable cost which is far greater with respect to the cost of the household appliances and then the present domotic systems have the unquestionable limitation that they are not easily within the reach to all family incomes because of their cost.

Another drawback of the present domotic systems regarding particularly the control of household appliances is due to the fact that they are connected to the remote control unit by electric cables of the electric system of the house, and the control unit is fixed and not portable.

A further drawback is due to the fact that if a company manufacturing a household appliance or more generally any machine provided with software would update the software of the latter, it could easily run the risk to see its own technological know-how revealed because there is no system for the automatic updating of software without technical staff.

The main object of the present invention is to fully overcome the limitations and the problems of the present domotic systems by providing a novel centralized domotic system able to remote control and manage household appliances, apparatuses, installations, devices, machines, etc. existing in a dwelling-house, thus further allowing the cost of the whole domotic system to be minimized so that the latter can be within the reach also to less well-off families.

A further object of the present invention is at the same time to allow each manufacturer of the household appliances, apparatuses, installations, devices and machines provided with specific software and existing in a dwelling-house to update such software easily, continuously, remotely and automatically, i.e. without the intervention of technical staff as well as without running the risk to see its own technological know-how revealed.

These objects are achieved by providing a domotic system to carry out drive, control and centralized management of a plurality of household appliances, thermostats, safety systems, lights, apparatuses, machines, installations, etc. existing in a dwelling-house, which essentially consists of a remote logic drive, control and management unit which is installed at home and a plurality of household appliances, thermostats, safety systems, lights, apparatuses, machines, installations, etc., characterized in that said plurality of household appliances, thermostats, safety systems, lights, apparatuses, machines, installations, etc. are all lacking in their specific man-machine interface components both of electronic (such as display, monitor, LEDs, etc.) and mechanical (such as knobs, buttons, levers, etc.) kinds, said plurality of elements being remote driven, controlled and managed by means of a plurality of suitable radio transceivers with limited power and low cost that are installed on board of said components and communicate directly with said remote logic unit.

These objects and the relative advantages as well as features of the system according to the present invention will result more clearly from the following description of a preferred exemplary, not limiting embodiment with particular reference to the accompanying drawings, in which:

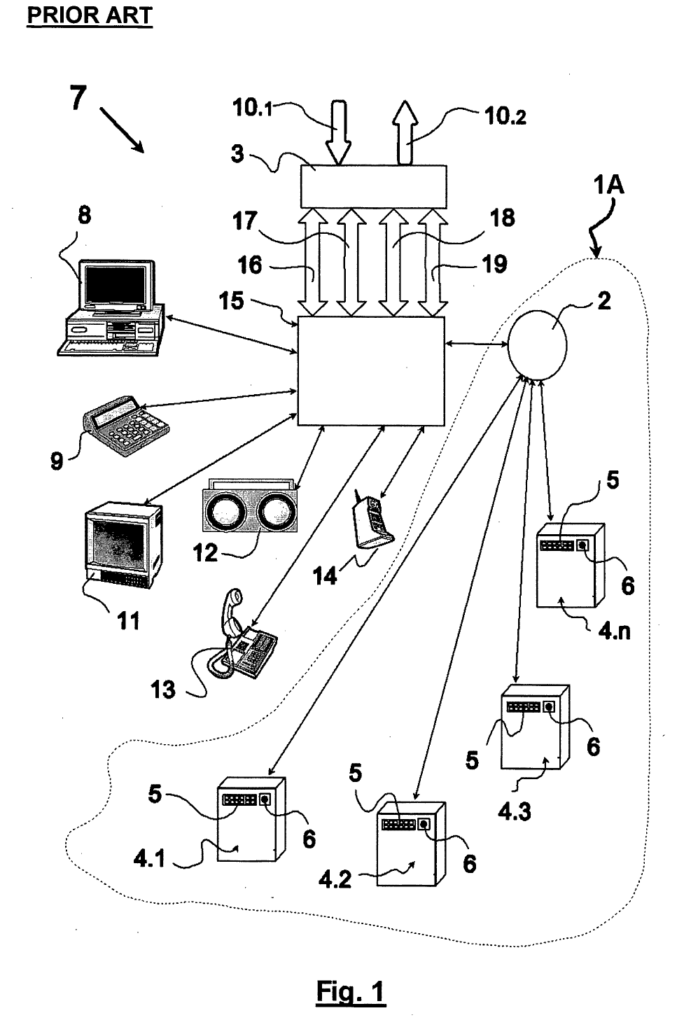

FIG. 1 is a schematic view of a domotic agency 7 of the known type which is useful to a better understanding of the specific field of application of the invention, in which the domotic system of the known type 1A is designated by dashed lines;

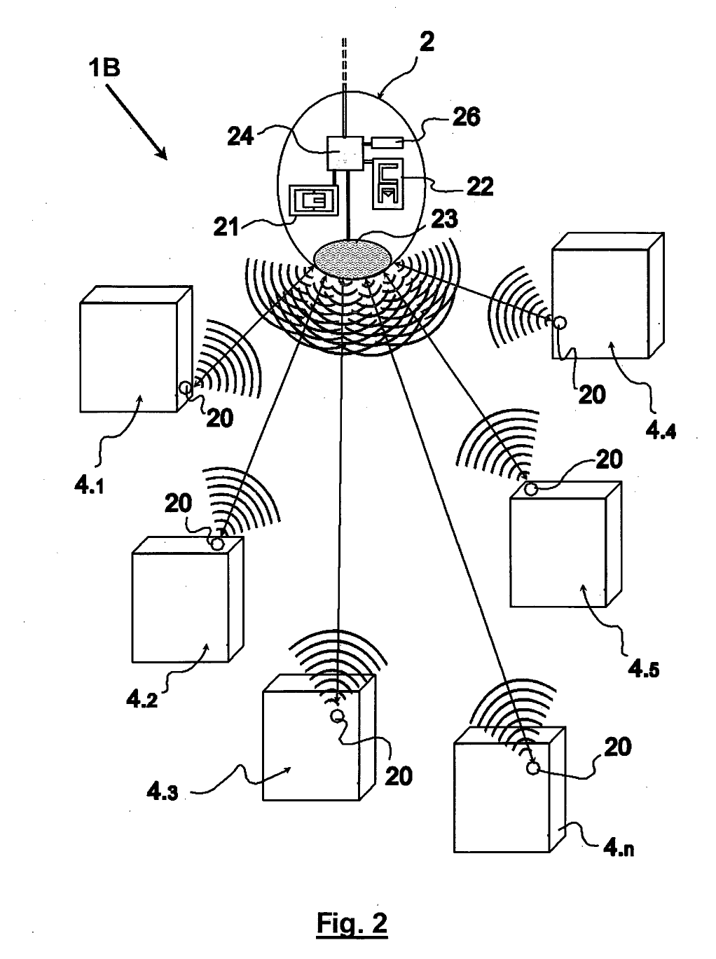

FIG. 2 is a schematic view of a preferred embodiment of a domotic system 1B according to the invention essentially consisting of a remote logic unit 2 and a plurality of household appliances, thermostats, safety systems, lights, apparatuses, machines, installations, etc. 4.1-4.2-4.3- . . . -4.n, interacting via radio with the remote logic unit 2 during the ordinary management of the dwelling-house;

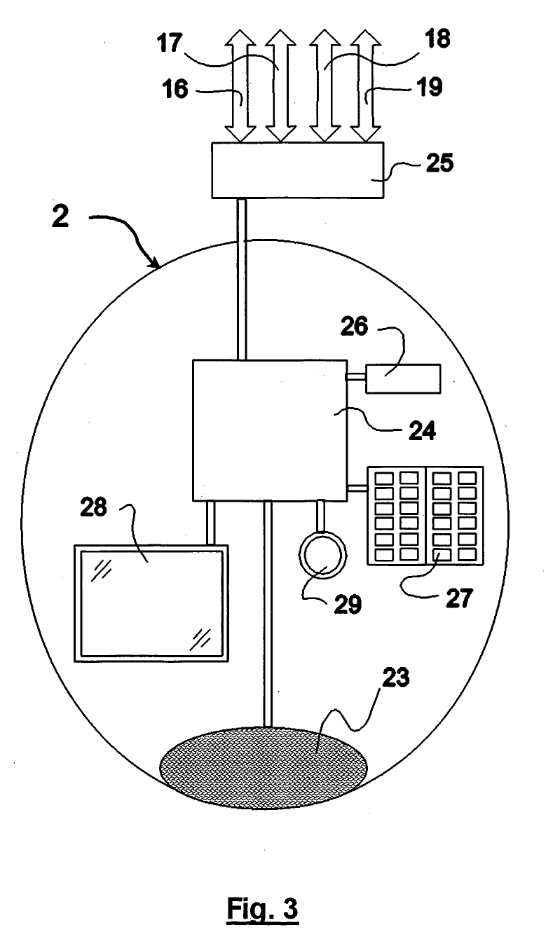

FIG. 3 is a schematic view of a preferred, not limiting solution of a possible embodiment of the remote logic unit 2 of the domotic system 1B of FIG. 2.

With reference to FIG. 1 showing an example of the prior art, a domotic agency 7 consists preferably of a central connection unit 15 to which there are connected:
one or more PCs (personal computers) 8 by data net for PC,
one or more PDAs (personal digital assistants) 9 such as palmar computers by wireless data net such as radio or light waves or more generally electromagnetic waves,
one or more television sets 11 and/or stereo equipments 12 by distribution and entertainment nets,
one or more fixed 13 and/or mobile 14 telephone apparatuses operating via cable and via radio, respectively,
al last, a remote logic unit 2 of a domotic system 1A, which logic unit 2 is able to connect domotic system 1A to central connection unit 15 and through the latter to a plurality of household appliances, thermostats, safety systems, lights, apparatuses, machines, installations, etc. 4.1 . . . 4.n, all of them provided with specific man-machine interface components both of electronic kind 5 such as display, monitor, LEDs, etc. and mechanical kind 6 such as knobs, buttons, levers, etc.

Furthermore, a plurality of communication means such as a power line modem connected via electric system 16, a wireless, radio or light, transmitter 17, one or more telephone lines 18, a LAN, Ethernet or intranet 19 (preferably of class 5), carry out broadband services by input 10.1 and output 10.2 data transmission through a network gateway 3 connected through said communication means 16-19 to central connection unit 15.

Said known domotic system 1A has been shown enclosed by a dashed line to better emphasize the specific field of application of the present invention inside the whole assembly of FIG. 1 shown as a technically known illustrative example, the so-called domotic agency 7.

Next FIG. 2 shows a diagram of a preferred, not limiting embodiment of a domotic system 1B according to the invention.

Domotic system 1B shown in FIG. 2 is similar at first sight to the known domotic system 1A shown in FIG. 1 as it like the latter consists essentially of a remote logic unit 2 installed near the controlled and managed apparatuses and/or installations 4.1 . . . 4.n for data exchange.

Said apparatuses and/or installations to be controlled and managed consist for example of a plurality of household appliances, thermostats, safety systems, lights, apparatuses, machines, installations, etc. According to a first peculiar feature of the finding said apparatuses and/or installations to be controlled and managed 4.1 . . . 4.n, are provided each with a respective radio transceiver 20 by which they are remote driven, controlled and managed from said remote logic unit 2.

A second peculiar feature of the present invention consists in that said apparatuses to be controlled and managed 4.1 . . . 4.n are all lacking in their specific man-machine interface components both of electronic 5 (such as display, monitor, LEDs, etc.) and/or mechanical 6 (such as knobs, buttons, levers, etc.) kinds.

Said radio transceivers 20 installed on board of each apparatus are electronic devices with a very low cost preferably of the SRD (Short Range Device) type as they have a low transmission range with the consequent low market cost.

Another feature of domotic system 1B disclosed is that said remote logic unit 2 which drives, controls and manages said plurality of apparatuses 4.1 . . . 4.n is portable and also provided with a specific centralized man-machine interface electronics 21 and mechanics 22 which is of simple and easy use and economic as well. A further feature of domotic system 1B according to the present invention is that said plurality of apparatuses 4.1 . . . 4.n provided with their own radio transceiver 20 are in remote, interactive communication with portable remote logic unit 2 and through a docking station 25 to the respective manufacturing companies.

In fact, FIG. 3 shows a schematic diagram of a preferred embodiment of remote logic unit 2 according to the invention consisting of a particular exemplary embodiment of the main components.

In this embodiment said portable remote logic drive, control and management unit 2 includes essentially:
a central radio transceiver 23,
a microcontroller 24,
a storage battery 26,
a specific man-machine interface component set consisting for example of a push-button panel 27, a video display 28 for displaying collected and transmitted data, and a buzzer 29 for signalling data input at any time.

In particular, each apparatus 4.1 . . . 4.n communicates with said central radio transceiver 23 through respective radio transceiver 20 so that software updating can be received automatically from the respective manufacturing companies. The connection to the latter is performed by said docking station 25 which can be interfaced with remote logic unit 2 and is provided with a modem connected via electric system 16, and/or a wireless, radio or light, transmitter 17, and/or one or more telephone lines 18, and/or a LAN 19, i.e. Ethernet, intranet, Internet, preferably of class 5, or other equivalent means for input and output data transmission from logic unit 2.

Said central radio transceiver 23 interacts via radio with each apparatus 4.1 . . . 4.n transmitting and receiving control data of the latter as well as updating the software periodically and/or on demand by a direct connection to the manufacturing companies.

Advantageously, the transmission/reception can be carried out, as already mentioned, by a plurality of known communication means 16-17-18-19 through said docking station 25.

Domotic system 1B according to the present invention is able to update continuously the firmware, i.e. the software installed by the manufacturing companies on board of their own apparatuses 4.1 . . . 4.n in a quick, safe manner without running the risk that the know-how of the manufacturing company can be revealed.

In other words, the disclosed domotic system 1B allows the manufacturers of household appliances to load and update software independently and remotely also in control logic unit or console 2 and to define the functions available in each household appliance without third parties interfere in console 2. This means that the intervention of third parties for the conversion of the graphical interfaces and the operations that can be controlled by display is not necessary because each manufacturer will have a general-purpose, standardized development environment which can be provided, for example, by a software loaded on the console of the so-called “virtual machine” type (e.g. Java).

In addition, the unquestionable advantage of the present invention consists in that the additional paltry cost of radio transceivers 20 to be installed on board of the single apparatuses 4.1 . . . 4.n adds to the considerable saving consisting of the removal of the interface electronics and mechanics which are now installed only in remote logic unit 2 driving, controlling and managing the whole domotic system 1B with a considerable reduction in cost allowing the invention to be within the reach to all families.

As can be appreciated, the advantages of the present invention consist above all of the provision of a simple domotic system 1B which is technically safe and can be implemented with a minimum final cost.

The domotic system disclosed has also the advantage of being useful not only for the final users but also for the manufacturing companies of the single household appliances, thermostats, safety systems, lights, apparatuses, machines, installations, etc.

The feasibility of the continuous software updating by the manufacturing companies will provide a base of household appliances always updated with new technologies with a number of self-evident advantages such as:
the protection of the environment as the household appliances thus conceived will allow water and cleansing agents to be used with optimum efficiency,
a better use of the power as the consumption can be optimised as far as the effective use of the household appliance is concerned,
lower management cost for the final user due to a lower power and primary-product consumption, thus producing lower cost associated to the management of the household appliances.

A further advantage of the whole system consists of a high rationalization of the maintenance: the control system is able to signalise the failures to the technical assistance centres or customer service in real time. Thus, the remote monitoring of the normal operation and use of a large number of household appliances will be possible with evident rationalization of the activity of the technical assistance centres.

Another advantage of the present invention is the conceiving of the domotic-system production cost minimization that can be obtained by a very easy technological method to be carried out by means of the simple innovations of the finding.

At last it should be appreciated that docking station 25, which is connected to remote logic unit 2 for the management of apparatuses, devices and installations 4.1 . . . 4.n existing in a dwelling-house, can be connected to a smart inverter of the known type associated to electric photovoltaic sources or other alternative power sources. Thus, docking station 25 receives data about consumptions from the inverter so that it can produce a signal causing the load to be switched off and/or carries out directly such an operation as a function of the parameters adjusted by the user.

In conclusion, it should be appreciated that the present invention provides that the manufacturing companies do not sell the household appliance to the user but only the service associated thereto: for example, in case of a washing machines, they sell only the wash. In these cases, the manufacturing company is not bound to install a counter in each household appliance to detect how many times the latter is used and/or by what program, the user just paying the service obtained by that household appliance only when and if he uses it. The use of the household appliances is controlled by remote unit or console 2 which is managed by the user.

It is self-evident that anyone skilled in the art can make a number of functionally equivalent modifications, adaptations, integrations, variations and replacements to the domotic system disclosed above by way of an illustrative, not limiting embodiment without departing from the scope of protection of the following claims.

1-12. (canceled)

13. A domotic system (1B) for the centralized drive, control and management of domestic appliances, devices, apparatuses, installations (4.1 . . . 4.n) existing in a dwelling-house, consisting of a logic unit (2) of remote drive, control and management and a plurality of said apparatuses, devices and installations (4.1 . . . 4.n), wherein said apparatuses, devices and installations (4.1 . . . 4.n) are provided each with wireless communication means (20) by which they are remote driven, controlled ad managed by said remote logic unit (2) which is also provided with its own central wireless communication means (23), characterized in that said apparatuses, devices and installations (4.1 . . . 4.n) are all lacking in their man-machine interface components both of electronic kind (5) such as display, monitor, LEDs, etc. and mechanical kind (6) such as knobs, buttons, levers, etc.; being further provided a docking station (25) suitable to be connected to remote logic unit (2), which docking station (25) communicates with a smart inverter of the known type associated to electric photovoltaic sources or other alternative power sources so that docking station 25 can receive data about consumptions from the inverter so that it can produce a signal causing the load to be switched off and/or carries out directly such an operation as a function of the parameters adjusted by the user.

14. The domotic system (1B) according to claim 13, characterized in that said wireless communication means consists of respective radio transceivers (20), and said central wireless communication means of remote logic unit (2) consists of a central transceiver (23) able to communicate with each said transceiver (20).

15. The domotic system (1B) according to claim 14, characterized in that said transceivers (20) installed on board of each apparatus are electronic SRD (Short Range Devices).

16. The domotic system (1B) according to claim 13, characterized in that said remote logic unit (2) driving, controlling and managing said plurality of apparatuses (4.1 . . . 4.n) is provided with its own centralized man-machine interface means of electronic (21) and/or mechanical (22) kinds.

17. The domotic system (1B) according to claim 13, characterized in that said remote logic unit (2) is portable.

18. The domotic system (1B) according to claim 13, characterized in that said docking station (25) is able to communicate with the respective companies of manufacturing of apparatuses, devices, and installations (4.1 . . . 4.n), thus providing that the latter can exchange data with their own manufacturing companies through logic unit (2) and docking station (25).

19. The domotic system (1B) according to the claim 13, characterized in that said remote logic unit (2) includes said docking station (25).

20. The domotic system (1B) according to claim 13, characterized in that said portable remote logic unit (2) for driving, controlling and managing apparatuses includes essentially:
a central transceiver (23),
a microcontroller (24),
a storage battery (26),
a specific man-machine interface component set consisting for example of a push-button panel (27), a video display (28) for displaying data collected and transmitted, and a buzzer (29) for signalling data input at any time.

21. The domotic system (1B) according to claim 17, characterized in that said remote logic unit (2) has the size of a manual remote control and is provided with an electronic (21) and mechanical (22) man-machine interface that can be used to manage the operations of all apparatuses, devices and installations (4.1 . . . 4.n).

22. A domotic agency (7) for driving, controlling and managing centrally apparatuses and installations (4.1 . . . 4.n) existing in a dwelling-house, characterized in that there is provided a domotic system (1B) according to claim 13.
